(19) United States
(12) Patent Application Publication
(10) Pub. No.: US 2015/0248322 A1
(43) Pub. Date: Sep. 3, 2015

(54) MEMORY CONTROLLER AND MEMORY SYSTEM

(71) Applicant: Kabushiki Kaisha Toshiba, Minato-ku (JP)

(72) Inventors: Tokumasa Hara, Kawasaki-shi (JP); Hitoshi Iwai, Kamakura-shi (JP); Naoya Tokiwa, Fujisawa-shi (JP); Toshikatsu Hida, Yokohama-shi (JP); Yoshihisa Kojima, Kawasaki-shi (JP); Hiroshi Sukegawa, Nerima-ku (JP); Shirou Fujita, Kamakura-shi (JP)

(73) Assignee: Kabushiki Kaisha Toshiba, Minato-ku (JP)

(21) Appl. No.: 14/339,717

(22) Filed: Jul. 24, 2014

Related U.S. Application Data
(60) Provisional application No. 61/946,517, filed on Feb. 28, 2014.

(51) Int. Cl. G06F 11/07

(52) U.S. Cl. CPC G06F 11/0775

(57) ABSTRACT

According to one embodiment, a memory controller includes a controller that is configured to, when notified of an error by one of memory chips at a time of power supply startup, transmit a first command including an address to the memory chip by which the error was notified, when notified of a normal end by the memory chip in which the first command was received, transmit a second command including an address to the memory chip by which the normal end was notified.

### CROSS-REFERENCE TO RELATED APPLICATIONS

This application is based upon and claims the benefit of priority from U.S. Provisional Patent Application No. 61/946,517, filed on Feb. 28, 2014; the entire contents of which are incorporated herein by reference.

### FIELD

Embodiments described herein relate generally to a memory controller that controls a nonvolatile memory and a memory system.

### BACKGROUND

A memory system that uses a nonvolatile memory such as a flash memory includes a storage unit including one memory chip or a plurality of memory chips, and a controller controlling the storage unit. Each of the memory chips includes a memory cell array as a data storage area, a peripheral circuit that performs read and write of data from and to the memory cell array, various kinds of registers, and the like.

Various kinds of parameter data necessary for various kinds of circuits in each of the memory chips to operate are stored in the memory cell array. The peripheral circuit reads the parameter data from the memory cell array at the time of startup of a power supply and sets the read parameter data in the registers. The peripheral circuit operates based on the parameter data set in the registers, whereby each of the memory chips can perform a normal operation.

If any one of the memory chips fails to read the parameter data, this leads to a failure of the storage unit. Accordingly, improvement in reliability of the parameter data is demanded.

### BRIEF DESCRIPTION OF THE DRAWINGS

FIG. 1 is a block diagram illustrating a configuration example of a memory system;

FIG. 2 is a block diagram illustrating an internal configuration example of a memory chip;

FIG. 3 is a conceptual diagram illustrating a recovery method of a parameter according to a first embodiment;

FIG. 4 illustrates an example of a data structure of a parameter set group;

FIG. 5 illustrates another example of parameter data;

FIG. 6 is a flowchart illustrating a parameter self-read process in a memory chip;

FIG. 7 is a flowchart illustrating a multiplexing process of a parameter;

FIG. 8 is a flowchart illustrating an operation procedure of a controller and memory chips at the time of power supply startup of the memory system according to the first embodiment;

FIG. 9 illustrates another example of a storage mode of the parameter according to the first embodiment;

FIG. 10 is a flowchart illustrating an operation procedure of a controller and memory chips at the time of power supply startup of a memory system shown in FIG. 9;

FIG. 11 is a flowchart illustrating an operation procedure of a controller and memory chips at the time of power supply startup of a memory system according to a second embodiment;

FIG. 12 is a conceptual diagram illustrating a recovery method of a parameter according to a third embodiment;

FIG. 13 illustrates an example of a data structure of a parameter set group according to the third embodiment;

FIG. 14 is a flowchart illustrating an operation procedure of a controller and memory chips at the time of power supply startup of a memory system according to the third embodiment;

FIG. 15 is a flowchart illustrating an operation procedure of a controller and memory chips at the time of power supply startup of a memory system according to a fourth embodiment;

FIG. 16 is a conceptual diagram illustrating processing in a fifth embodiment;

FIG. 17 is a conceptual diagram illustrating parameter reconfiguration;

FIG. 18 is a flowchart illustrating an operation procedure of a controller and memory chips at the time of power supply startup of a memory system according to the fifth embodiment;

FIG. 19 is a flowchart illustrating an operation procedure of a controller and memory chips at the time of power supply startup of a memory system according to a sixth embodiment; and

FIG. 20 is a flowchart illustrating an operation procedure of a controller and memory chips at the time of power supply startup of a memory system according to a seventh embodiment.

### DETAILED DESCRIPTION

According to one embodiment, a memory controller controls a nonvolatile memory. The nonvolatile memory has one memory chip or a plurality of memory chips. The memory controller includes a controller. The controller is configured to, when notified of an error by one of the memory chips at a time of power supply startup, transmit a first command including an address to the memory chip by which the error was notified and, when notified of a normal end by the memory chip in which the first command was received, transmit a second command including an address to the memory chip by which the normal end was notified.

Furthermore, the controller is configured to, when notified of an error by one of the memory chips at a time of power supply startup, transmit a first command for causing data to be transmitted from a memory chip to the memory chip by which the error was notified, then after correcting data received from the memory chip, transmit the corrected data to the memory chip, and, when notified of a normal end by the memory chip in which the corrected data was received, transmit a second command including an address to the memory chip by which the normal end was notified.

Exemplary embodiments of a memory controller and a memory system will be explained below in detail with reference to the accompanying drawings. The present invention is not limited to the following embodiments.

### First Embodiment

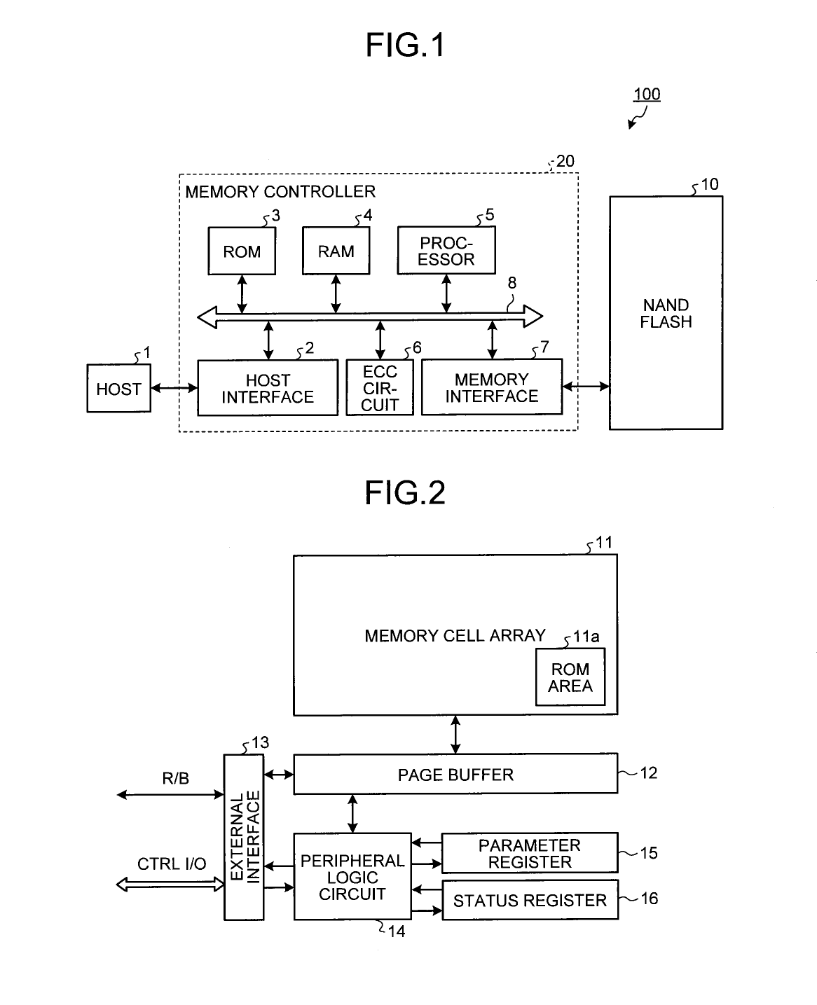

FIG. 1 illustrates a configuration example of a memory system 100. The memory system 100 includes a memory controller 20 and a NAND flash 10 (hereinafter, NAND) as a nonvolatile memory. The nonvolatile memory is not limited to a nonvolatile semiconductor memory such as the NAND flash 10 and can be any data storable memory such as a three-dimensional flash memory, a ReRAM (Resistance Random Access Memory), or a FeRAM (Ferroelectric Random Access Memory).

The NAND 10 includes one memory chip or a plurality of memory chips. Each of the memory chips has a memory cell array 11 (see FIG. 2) in which a plurality of memory cells is arranged in a matrix. Each of the memory cells is capable of multivalued storage. The memory cell array 11 is configured by arraying a plurality of physical blocks each being a unit of data erasing. In the NAND 10, data write and data read are performed per physical page. Each of the physical blocks includes a plurality of physical pages.

The memory controller 20 has a host interface 2, a ROM (Read Only Memory) 3, a RAM (Random Access Memory) 4, a processor 5, an ECC circuit 6, a memory interface 7, and a bus 8 that connects these constituent elements.

The memory system 100 is connected to a host device (hereinafter, “host”) 1 via the host interface 2 and functions as an external storage device of the host 1. The host 1 is, for example, a personal computer, a mobile phone, or an imaging device.

The host interface 2 receives commands such as a read command and a write command from the host 1 via a communication interface such as a SATA (Serial Advanced Technology Attachment) or a SAS (Serial Attached SCSI). Upon reception of a command from the host 1, the host interface 2 reserves a necessary buffer area on the RAM 4 and notifies the processor 5 of the command. The host interface 2 executes a control on data transfer between the host 1 and the RAM 4 under a control of the processor 5.

A startup program for starting the processor 5 is stored in the ROM 3. The startup program stored in the ROM 3 includes a program for performing a recovery process of parameter data, which will be explained later.

The RAM 4 has a storage area for temporarily storing therein data from the host 1 when the data is to be written to the NAND 10, a storage area for storing or updating management information such as an address conversion table that associates logical addresses (LBAs, for example) transmitted from the host 1 with storage positions of data on the NAND 10, and the like. The management information is backed up in the NAND 10.

The memory interface 7 executes a control on data transfer between the NAND 10 and the RAM 4 under a control of the processor 5.

The ECC (Error Correcting Code) circuit 6 performs an encoding process using an error correcting code with respect to data transferred from the RAM 4 and outputs the data to the memory interface 7 with an encoding result attached to the data. The memory interface 7 outputs the data attached with the error correcting code, which is input from the ECC circuit 6, to the NAND 10. The ECC circuit 6 performs a decoding process using the error correcting code with respect to data read from the NAND 10 via the memory interface 7 and outputs error-corrected data to the RAM 4.

The processor 5 generally controls internal circuits of the memory controller 20. The processor 5 performs processes such as:

a process of writing write data to the NAND 10 via the RAM 20 and a process of reading data from the NAND 10;

organization of data (compaction); and

an update process of the management information.

The processor 5 realizes the functions with software (firmware). The firmware is stored in the NAND 10. At the time of startup, the firmware is transferred to the RAM 4 by the startup program stored in the ROM 3 and executed by the processor 5.

FIG. 2 illustrates an internal configuration example of the memory chip included in the NAND 10. When the NAND 10 includes plural memory chips, other memory chips also have the same configuration. The memory chip includes the memory cell array 11, a page buffer 12, an external interface 13, a peripheral logic circuit 14, a parameter register 15, and a status register 16.

The memory cell array 11 includes a NAND memory cell array and has write data from the host 1 and the like stored therein. The memory cell array 11 includes a ROM area 11a in which the management information of the memory system 100 is stored. The ROM area 11a is a part of the memory cell array 11 and consists of NAND memory cells as the memory cell array 11. The management information includes parameter information necessary for the internal circuits of the memory chip to operate.

The page buffer 12 buffers therein one page of data to be written to the memory cell array 11. The page buffer 12 also buffers therein one page of data read from the memory cell array 11.

The external interface 13 performs transmission and reception of data to and from the memory interface 7 of the memory controller 20. The external interface 13 is connected to the memory interface 7 of the memory controller 20 via a control I/O (Ctrl I/O) signal line, a ready/busy (R/B) signal line, and the like. The Ctrl I/O signal line includes a control signal line including a write enable signal, a read enable signal, a data strobe signal, and the like, and an I/O signal line including a command, an address, and data.

The peripheral logic circuit 14 has a function to write data buffered in the page buffer 12 to the memory cell array 11, a function to buffer data read from the memory cell array 11 in the page buffer 12, a function to set the parameter information in the parameter register 15, and the like. The peripheral logic circuit 14 also has an error detecting function or an error correcting function. The error correcting function of the peripheral logic circuit 14 is lower in the correcting capability than the error correcting function of the ECC circuit 6.

The parameter register 15 has separate register areas corresponding to different parameters related to the relevant memory chip, respectively. The parameter information stored in the memory cell array 11 includes different pieces of parameter data such as an internal-voltage set value in the memory chip and an address of a page including a defective cell in the memory cell array 11. Pieces of information differing according to memory chips are set as the parameter information at the manufacturing stage of the memory chips.

The peripheral logic circuit 14 operates according to the parameters set in the parameter register 15. At the time of startup of the relevant memory chip, the peripheral logic circuit 14 reads the parameter information stored in the ROM area 11a and sets the read parameter information in the parameter register 15. This operation of reading the parameters and setting the parameters in the parameter register 15 by the peripheral logic circuit 14 is performed autonomously in each memory chip only the first time at the time of startup of the power supply, without being controlled by the memory controller 20.

Status information indicating a status of the relevant memory chip is set in the status register 16. The status information includes parameter-read success/failure information indicating a success or failure of read of parameters. For example, there are following three methods performed by the peripheral logic circuit 14 to notify the memory controller 20 of a parameter read success or failure:

When parameter read fails, the ready/busy signal (R/B signal) is not brought to a ready state and is kept busy even when a predetermined time has passed;

When parameter read fails, a status signal output from the memory chip via the I/O signal line is not brought to a ready state in response to a status read from the memory controller 20; and

When parameter read fails, data of a predetermined pattern (all “1”, for example) is not output from the I/O signal line even when a data transmission clock is toggled.

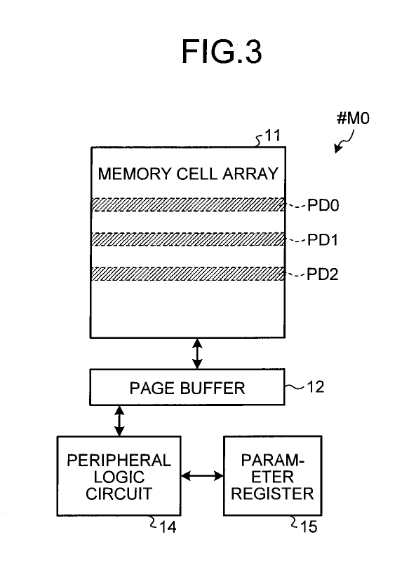

FIG. 3 illustrates an example of the parameter information stored in the memory cell array 11. FIG. 3 illustrates an internal configuration of a memory chip #M0. In FIG. 3, as parameter data related to the memory chip #M0, a first parameter set group PD0, a second parameter set group PD1, and a third parameter set group PD2 are stored in a distributed manner at different storage positions in the memory cell array 11 of the memory chip #M0, respectively. The first parameter set group PD0, the second parameter set group PD1, and the third parameter set group PD2 are the same data to provide multiplexing (triplicating). The first parameter set group PD0 is stored in the ROM area 11a of the memory array 11 at the manufacturing stage. The second parameter set group PD1 and the third parameter set group PD2 are formed by performing a multiplexing process to copy the first parameter set group PD0 at the time of use of the memory system 100. The first parameter set group PD0 is used in autonomous parameter read in each of the memory chips without intervention of the memory controller 20 and the second parameter set group PD1 and the third parameter set group PD2 are used in parameter read in each of the memory chips under the control of the memory controller 20, which will be explained later.

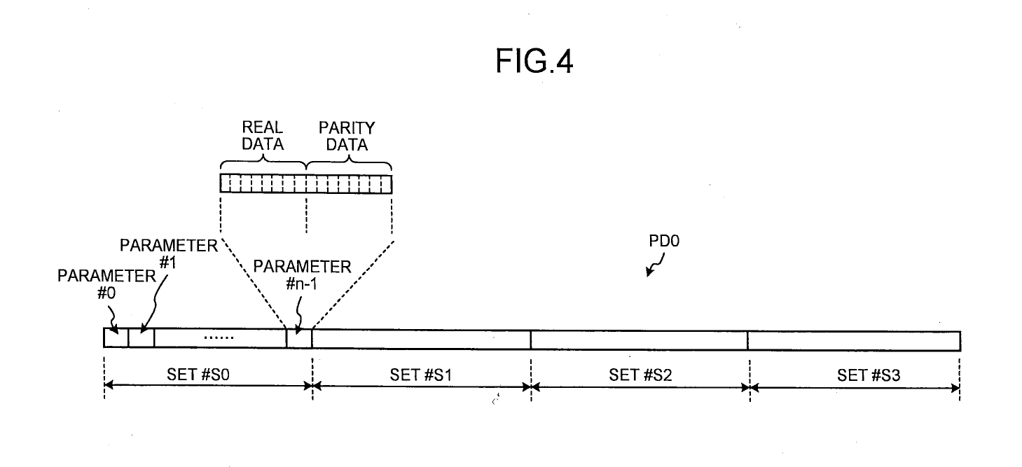

FIG. 4 illustrates a detailed configuration of the first parameter set group PD0. The second parameter set group PD1 and the third parameter group PD2 have the same data configuration shown in FIG. 4. The first parameter set group PD0 has a plurality of parameter sets to multiplex the parameter sets. In a case of FIG. 4, the first parameter set group PD0 has four parameter sets (sets #S0, #S1, #S2, and #S3). One parameter set includes a plurality of different pieces of parameter data #0 to #n−1. One piece of parameter data includes real data and redundant data. In FIG. 4, parity data as an error correcting code is used as the redundant data. For example, a hamming code is adopted as the error correcting code. The peripheral logic circuit 14 performs error detection or error correction of parameter data read from the memory cell array 11 using the parity data.

In one parameter set, different pieces of parameter data for operating the various circuits in the relevant memory chip are included as described above. The parameter data includes an internal-voltage set value in the memory chip, an address of a block including a defective cell in the memory cell array 11, and the like. The parameter data is defined at a product shipment stage and differs according to the memory chips. The block including a defective cell is handled, for example, as an unusable bad block.

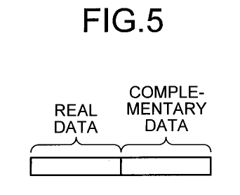

One piece of parameter data can include real data and complementary data having a complementary relation with the real data as shown in FIG. 5. The peripheral logic circuit 14 can detect an erroneous bit in the real data by reading the parameter data and comparing the real data and the complementary data with each other. When the complementary data is used as the redundant data, only the error detecting function is provided and the error correcting function is not provided.

As mentioned above, in the first embodiment, the parameter information is multiplexed by the parameter set groups PD0 to PD2. Each of the parameter set groups PD0 to PD2 is multiplexed by the parameter sets #S0 to #S3. One parameter set includes the pieces of parameter data #0 to #n−1.

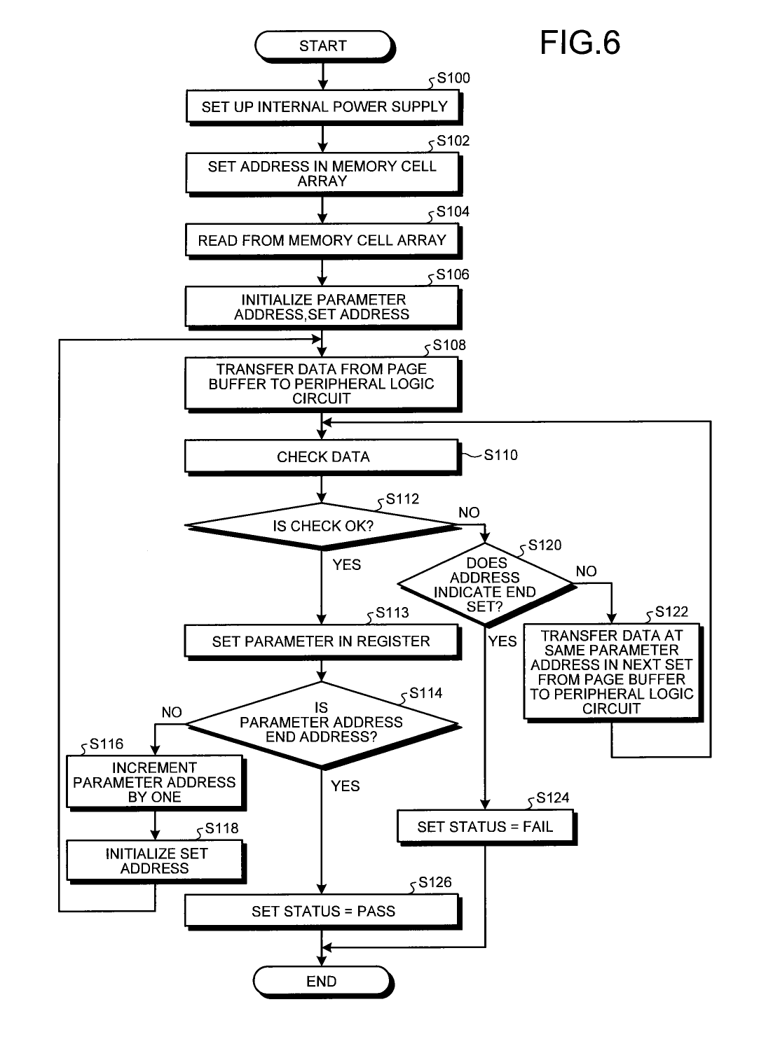

FIG. 6 illustrates an operation procedure of the autonomous parameter read mentioned above (hereinafter, “a parameter self-read process”) performed in each of the memory chips. The first parameter set group PD0 is stored in the ROM area 11a in the memory cell array 11. When the power supply is started or a reset signal is input from the memory controller 20, the peripheral logic circuit 14 of each of the memory chips first sets up an internal power supply (step S100) to set a physical address in the memory cell array 11, at which the first parameter set group PD0 is stored, in a register (not shown) (Step S102). The peripheral logic circuit 14 reads the first parameter set group PD0 from the memory cell array 11 using the physical address set in the register and buffers the read first parameter set group PD0 in the page buffer 12 (Step S104). The peripheral logic circuit 14 then initializes a parameter address to #0 and also initializes a set address to #S0 (Step S106).

The peripheral logic circuit 14 reads parameter data corresponding to the set address #S0 and the parameter address #0 from the page buffer 12 (Step S108). The peripheral logic circuit 14 performs data check (error detection or error correction) on the real data using the redundant portion of the read parameter data (Step S110).

When the data is determined to be normal in the data check (Yes at Step S112), the peripheral logic circuit 14 sets the real data portion of the read parameter data in the parameter register 15 (Step S113). The peripheral logic circuit 14 then determines whether the parameter address is the end address #n−1 (Step S114). When the parameter address is not the end address #n−1 at Step S114, the peripheral logic circuit 14 increments the parameter address by one (Step S116) and then initializes the set address to #S0 (Step S118). The peripheral logic circuit 14 then reads the parameter data corresponding to the set address #S0 and the parameter address #1 from the page buffer 12 (Step S108) and performs data check similar to that mentioned above (Step S110).

When the data is determined to be abnormal in the data check at Step S112, the peripheral logic circuit 14 determines whether the set address indicates the end set #S3 (Step S120) and, when the set address does not indicate the end set #S3, reads data having the same parameter address in the next set from the page buffer 12 (Step S122). The peripheral logic circuit 14 then performs error check on the parameter data read from the page buffer 12 (Step S110).

The peripheral logic circuit 14 repeats this procedure. At that time, when a read error occurs in the parameter data included in the end set #S3 at Step S120, the peripheral logic circuit 14 sets “Fail” in the status register 16 (Step S124). That is, “Fail” is set in the status register 16 when an error uncorrectable parameter occurs in all the sets in the data structure shown in FIG. 4 or when a matching error between the real data and the complementary data occurs in all the sets in the data structure shown in FIG. 5.

When it is determined in determination at Step S114 that all the parameters have been successfully read, the peripheral logic circuit 14 sets “Pass” in the status register 16 (Step S126). The peripheral logic circuit 14 notifies the memory controller 20 of whether the parameters have been successfully read using any of the three methods mentioned above.

In a memory system as a comparative example, each memory chip performs only an autonomous parameter read using the first parameter set group PD0. When even one parameter read error occurs in singular or plural memory chips included in the NAND 10, the processor 5 of the memory controller 20 regards this situation as a failure of the NAND 10. Mounting a high error correcting function on each memory chip causes a cost problem. Accordingly, improvement in reliability of the parameter data without causing the cost problem is demanded.

In the first embodiment, each of the memory chips has a function to read parameter data including an address (parameter data with an address, parameter data addressable) and, when an error occurs in self-read of the first parameter set group PD0, shifts to a state in which a parameter read command including an address is acceptable. When receiving a parameter read error from one of the memory chips at the time of power supply startup, the processor 5 of the memory controller 20 issues a command with address specification to the memory chip having transmitted the parameter read error so as to read data as parameters from the second parameter set group PD1 and further the third parameter set group PD2 previously multiplexed and stored. The memory chip having received this command performs the parameter read procedure shown at Steps S102 to S126 in FIG. 6 with respect to an address specified by the memory controller 20 (the second parameter set group PD1). When parameter read for the second parameter set group PD1 fails, the memory chip and the memory controller 20 perform the same processes as mentioned above, thereby performing parameter read for the third parameter set group PD2.

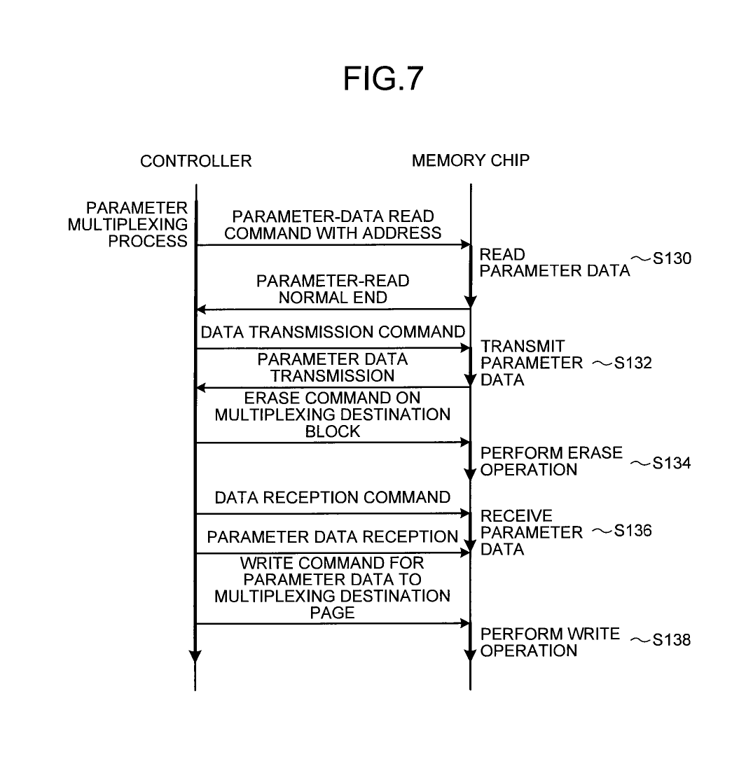

FIG. 7 illustrates a multiplexing process procedure of a parameter set group performed by the memory controller 20. In this multiplexing process, the first parameter set group PD0 is copied to different physical positions of the memory cell array 11 in the same memory chip, so that multiplexing of the second parameter set group PD1 and the third parameter set group PD2 is achieved. Basically, the multiplexing process procedure shown in FIG. 7 can be performed at an arbitrary time before occurrence of an uncorrectable read error in the set #S0 of the first parameter set group PD0. The multiplexing process procedure can be performed, for example, at the manufacturing stage or at the time of initial startup of the memory system 100.

When the multiplexing process is started, the memory controller 20 transmits a parameter-data read command with address specification (parameter-data read command with address) to each of the memory chips. The peripheral logic circuit 14 of the memory chip having received the parameter-data read command reads the first parameter set group PD0 from the specified address in the memory cell array 11 and buffers the read first parameter set group PD0 in the page buffer 12 (Step S130). When having the error correcting function, the peripheral logic circuit 14 performs error correction and then buffers the first parameter set group PD0 in the page buffer 12. When buffering into the page buffer 12 ends normally, the peripheral logic circuit 14 notifies the memory controller 20 of a normal end of the parameter read.

When receiving this notification, the processor 5 transmits a data transmission command to the memory chip. When receiving the data transmission command, the peripheral logic circuit 14 of the memory chip transmits the first parameter set group PD0 buffered in the page buffer 12 to the memory controller 20 (Step S132). The first parameter set group PD0 is buffered in the RAM 4 of the memory controller 20.

While data read from the memory cell array 11 to the page buffer 12 and data transfer from the page buffer 12 to the memory controller 20 are instructed to the memory chip with separate commands from the memory controller 20 in the first embodiment, these operations can be achieved with one command.

The processor 5 of the memory controller 20 transmits an erase command including addresses of multiplexing destination blocks to the memory chip to multiplex the first parameter set group PD0. Arbitrary blocks in the memory cell array 11 can be specified as the multiplexing destination blocks. The multiplexing destination blocks can be specified in the ROM area 11a or outside of the ROM area 11a. Because multiplexing is performed to create the second parameter set group PD1 and the third parameter set group PD2 in the first embodiment, two blocks are specified as the blocks to be erased.

When receiving the erase command, the peripheral logic circuit 14 of the memory chip erases the specified multiplexing destination blocks (Step S134).

The processor 5 of the memory controller 20 transmits a data reception command to the memory chip and also transits the first parameter set group PD0 received from the memory chip at Step S132 to the memory chip.

When receiving the data reception command and the first parameter set group PD0, the peripheral logic circuit 14 of the memory chip buffers the first parameter set group PD0 in the page buffer 12 (Step S136).

The processor 5 of the memory controller 20 then transmits a parameter-data write command with a page address indicating a storage destination of the second parameter set group PD1 to the memory chip.

When receiving the write command, the peripheral logic circuit 14 of the memory chip writes the first parameter set group PD0 buffered in the page buffer 12 to the multiplexing destination page specified in the memory cell array 11 (Step S138). Accordingly, the second parameter set group PD1 is stored in the memory cell array 11.

The processor 5 of the memory controller 20 further transmits a parameter-data write command with a page address indicating a storage destination of the third parameter set group PD2 to the memory chip.

When receiving the write command, the peripheral logic circuit 14 of the memory chip writes the first parameter set group PD0 buffered in the page buffer 12 to the multiplexing destination page specified in the memory cell array 11. Accordingly, the third parameter set group PD2 is stored in the memory cell array 11.

In this way, multiplexing of the parameter set groups is achieved.

When it is ensured that data in the page buffer 12 is not rewritten until a parameter-data write command with a multiplexing-destination page address is transmitted from the processor 5 of the memory controller 20 to the memory chip at Step S138 after the first parameter set group PD0 is read from the memory cell array 11 and buffered in the page buffer 12 at Step S130, the processes at Step S132 and S136 can be omitted.

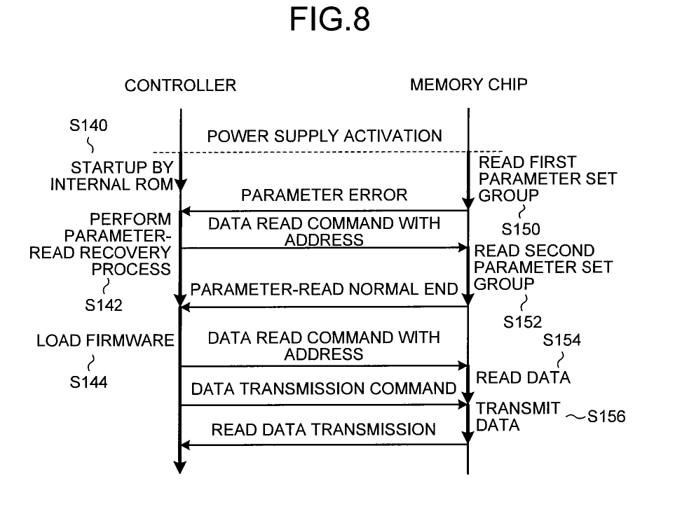

FIG. 8 illustrates operations of the memory controller 20 and each of the memory chips at the time of power supply startup of the memory system 100. Also when a reset signal is transmitted from the memory controller 20 to each of the memory chips after the power supply startup, the memory controller 20 and each of the memory chips perform the operations shown in FIG. 8.

When the power supply is started, the startup program stored in the internal ROM 3 is executed so that the processor 5 of the memory controller 20 is started (S140). The startup program stored in the internal ROM 3 includes programs for performing processes at Steps S142 and S144. Upon startup of the power supply, each of the memory chips performs the self-read of the first parameter set group PD0 shown in FIG. 6 (Step S150). A memory chip that has failed the self-read notifies the memory controller 20 of a parameter error.

When receiving the parameter error, the processor 5 of the memory controller 20 causes the memory chip to perform parameter read using the second parameter set group PD1 or the third parameter set group PD2 multiplexed in the procedure shown in FIG. 7 (Step S142). The processor 5 of the memory controller 20 first transmits a parameter-data read command including a page address at which the second parameter set group PD1 is stored to the relevant memory chip.

When receiving the parameter-data read command, the peripheral logic circuit 14 of the memory chip reads the second parameter set group PD1 from the specified address in the memory cell array 11 and buffers the second parameter set group PD1 in the page buffer 12 (Step S152). The peripheral logic circuit 14 performs the parameter read operation shown at Steps S102 to S126 in FIG. 6 using the second parameter set group PD1 buffered in the page buffer 12 and sets the pieces of parameter data in the parameter register 15. When the parameter data read ends normally, the peripheral logic circuit 14 of the memory chip notifies the memory controller 20 of a normal end of the parameter read.

When the parameter self-read operation using the second parameter set group PD1 fails, the memory controller 20 is notified of a parameter error and then similar processes are repeated using the third parameter set group PD2.

When receiving the normal end of the parameter read from each of the memory chips, the processor 5 of the memory controller 20 executes a read control on firmware from a desired memory chip (Step S144). The firmware includes a program for performing normal processing to be performed after parameter setting. Specifically, the processor 5 transmits a data read command including a page address at which the firmware is stored to the relevant memory chip and further transmits a data transmission command to the memory chip. Accordingly, when receiving the data read command and the data transmission command, the peripheral logic circuit 14 of the memory chip reads the firmware from the memory cell array 11 to buffer the firmware in the page buffer 12 (Step S154) and then transmits the firmware to the memory controller 20 (Step S156). The memory controller 20 stores the received firmware in the RAM 4 and the processor 5 executes the firmware stored in the RAM 4.

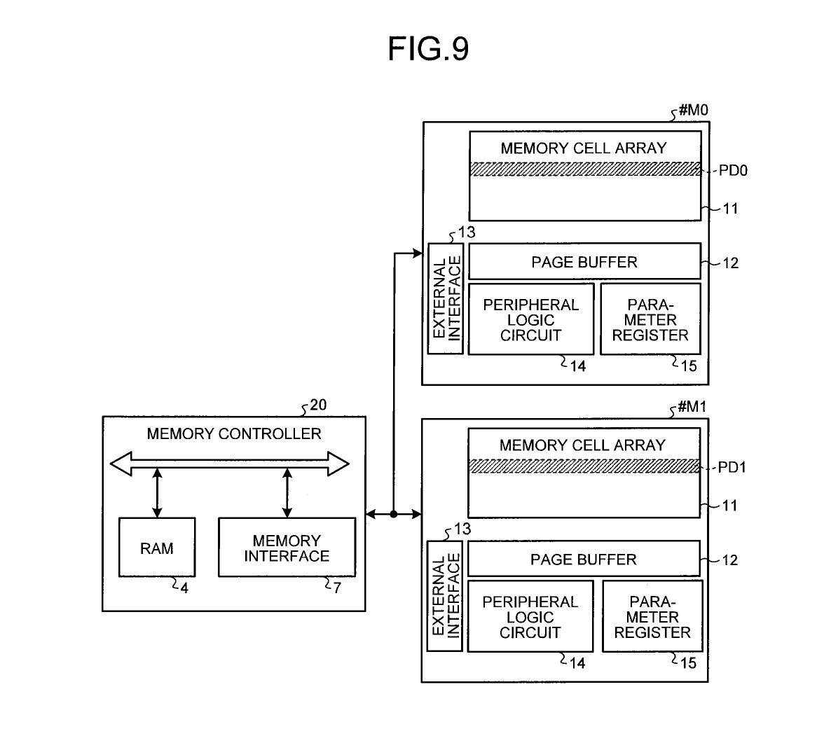

FIG. 9 illustrates a modification of the first embodiment. In this modification, multiplexing of the parameter set groups is performed using plural memory chips. The first parameter set group PD0 of the memory chip #M0 is stored in the memory cell array 11 of the memory chip #M0. The second parameter set group PD1 of the memory chip #M0 is stored in the memory cell array 11 of the memory chip #M1. That is, in this modification, the controller 20 copies the first parameter set group PD0 to the memory cell array 11 of the memory chip #M1 during the multiplexing process shown in FIG. 7.

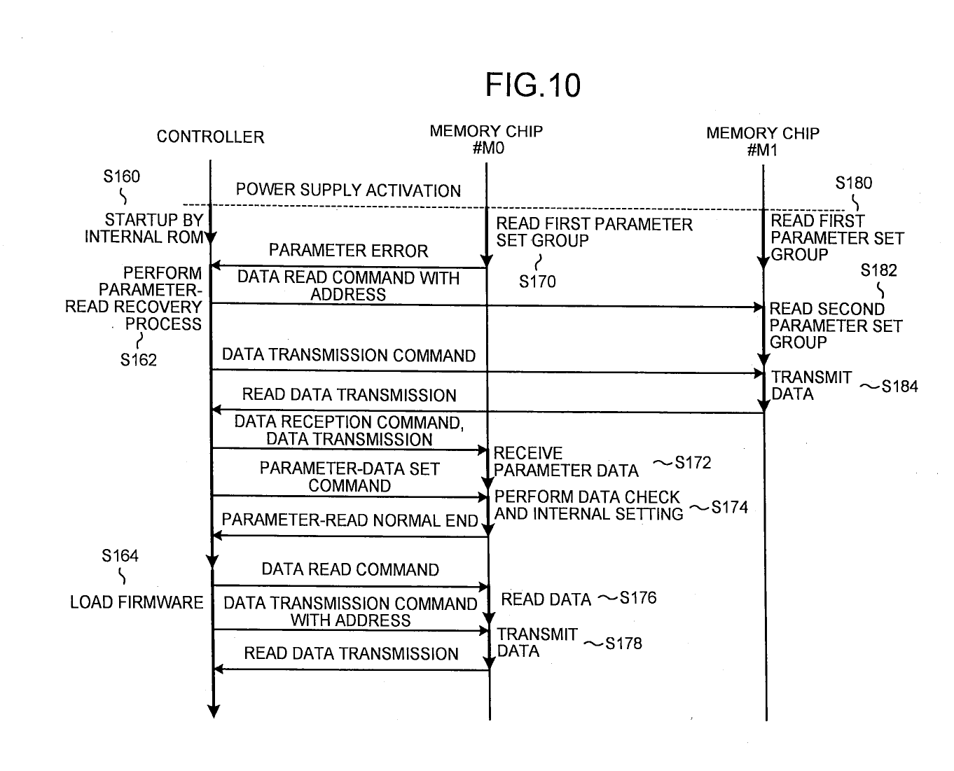

FIG. 10 illustrates operations of the memory controller 20 and the memory chips at the time of power supply startup of the memory system 100 shown in FIG. 9.

When the power supply is started, the startup program stored in the internal ROM 3 is executed so that the processor 5 of the memory controller 20 is started (Step S160). The startup program stored in the internal ROM 3 includes programs for performing processes at Steps S162 and S164. Upon startup of the power supply, the memory chips #M0 and #M1 each performs the self-read operation of the first parameter set group PD0 shown in FIG. 6 (Steps S170 and S180). The memory chip #M0 having failed the self-read operation notifies the memory controller 20 of a parameter error.

When receiving the parameter error from the memory chip #M0, the processor 5 of the memory controller 20 obtains the second parameter set group PD1 from the memory chip #M1, and performs parameter setting of the memory chip #M0 using the second parameter set group PD1 (Step S162). The processor 5 of the memory controller 20 first transmits a parameter read command with a page address at which the second parameter set group PD1 is stored and a data transmission command to the memory chip #M1.

When receiving the parameter-data read command, the peripheral logic circuit 14 of the memory chip #M1 reads the second parameter set group PD1 from the specified address in the memory cell array 11 and buffers the second parameter set group PD1 in the page buffer 12 (Step S182). The peripheral logic circuit 14 of the memory chip #M1 transmits the second parameter set group PD1 buffered in the page buffer 12 to the memory controller 20 (Step S184). The second parameter set group PD1 is buffered in the RAM 4 of the memory controller 20.

When receiving the second parameter set group PD1 from the memory chip #M1, the processor 5 of the memory controller 20 transmits a data reception command and the second parameter set group PD1 to the memory chip #M0. When receiving the data reception command and the second parameter set group PD1, the peripheral logic circuit 14 of the memory chip #M0 buffers the received second parameter set group PD1 in the page buffer 12 (Step S172). Upon reception of a parameter-data set command, the peripheral logic circuit 14 of the memory chip #M0 performs a parameter checking process and a parameter setting process shown at Steps S106 to S126 in FIG. 6 using the second parameter set group PD1 buffered in the page buffer 12 (Step S174). In this way, the parameters are set in the parameter register 15 of the memory chip #M0. The peripheral logic circuit 14 of each of the memory chips notifies the memory controller 20 of a normal end of the parameter read.

When receiving the parameter-read normal end from each of the memory chips, the processor 5 of the memory controller 20 executes a read control on firmware from a desired memory chip (Step S164). Specifically, the processor 5 transmits a data read command including a page address at which firmware is stored to the relevant memory chip and further transmits a data transmission command to the memory chip. Accordingly, when receiving the data read command and the data transmission command, the peripheral logic circuit 14 of the memory chip reads the firmware from the memory cell array 11 to buffer the read firmware in the page buffer 12 (Step S176) and then transmits the firmware to the memory controller 20 (Step S178). The memory controller 20 stores the received firmware in the RAM 4 and the processor 5 executes the firmware stored in the RAM 4.

As described above, in the first embodiment, the parameter set group of each of the memory chips is multiplexed and, when an error occurs in self-read of the first parameter set group PD0, the processor 5 of the memory controller 20 controls each of the memory chips to read parameters from the second parameter set group PD1 and then the third parameter set group PD2 multiplexed and stored. Therefore, the reliability of the parameter information can be improved without causing any cost problem and thus the reliability of the memory system can be improved.

### Second Embodiment

In a second embodiment, when read of the first parameter set group PD0 has failed and the second parameter set group PD1 has been successfully read, the first parameter set group PD0 is rewritten (refreshed) with the second parameter set group PD1.

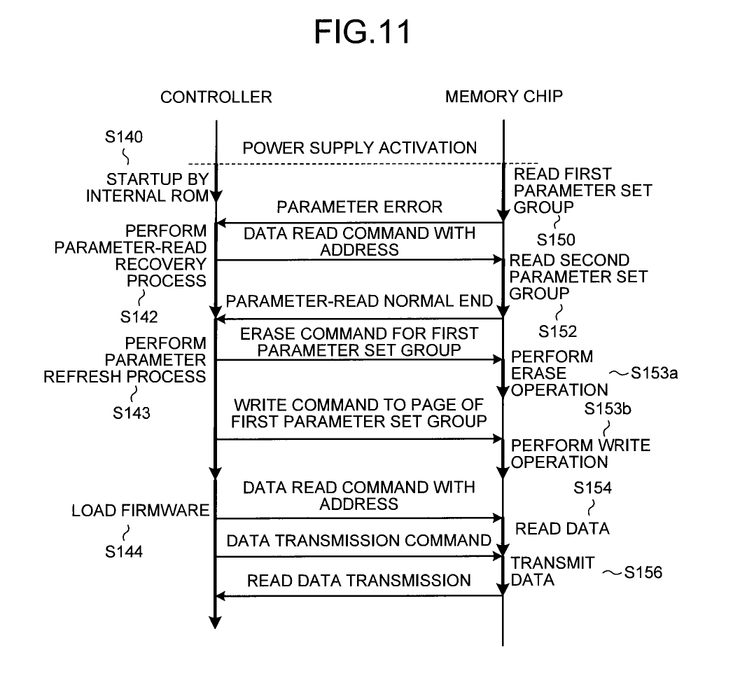

FIG. 11 illustrates an operation of the memory system 100 according to the second embodiment at the time of power supply startup. In FIG. 11, Steps S143, S153a, and S153b are added to the flowchart shown in FIG. 8.

As shown in FIG. 11, when read of the second parameter set group PD1 ends normally at Step S152, the peripheral logic circuit 14 of a relevant memory chip notifies the memory controller 20 of a normal end of the parameter read. When the read of the second parameter set group PD1 has ended normally, the second parameter set group PD1 is in a state buffered in the page buffer 12.

When receiving the normal end of the parameter read, the processor 5 of the memory controller 20 performs a refresh process to rewrite the first parameter set group PD0 with the second parameter set group PD1. Specifically, the processor 5 transmits an erase command including an address of a block in which the first parameter set group PD0 is stored to the relevant memory chip.

When receiving the erase command, the peripheral logic circuit 14 of the memory chip erases the specified block (Step S153a).

Further, the processor 5 of the memory controller 20 transmits a write command including an address of a page in which the first parameter set group PD0 has been stored to the memory chip.

When receiving the write command, the peripheral logic circuit 14 of the memory chip writes data buffered in the page buffer 12 to the page specified by the write command. Because the second parameter set group PD1 has been buffered in the page buffer 12 at that stage, the second parameter set group PD1 is written to the page in which the first parameter set group PD0 has been stored. As a result, the first parameter set group PD0 is rewritten with the second parameter set group PD1, thereby achieving the refresh process.

When a read error occurs in the second parameter set group PD1, a refresh process to rewrite the first parameter set group PD0 and the second parameter set group PD1 with the third parameter set group PD2 is performed.

In the second embodiment, because refresh to rewrite the first parameter set group PD0 for which a read error has occurred with the second parameter set group PD1 for which read has ended normally is performed, the possibility of a read error in the first parameter set group PD0 at the time of the next and succeeding startup is reduced and thus the parameter setting process is speeded up.

### Third Embodiment

In a third embodiment, the error correcting code used in the ECC circuit 6 of the memory controller 20 is added to parameter data. When a parameter read error occurs in a memory chip, the ECC circuit 6 of the memory controller 20 performs error correction and sets the error-corrected parameter data in the parameter register 15 of the memory chip.

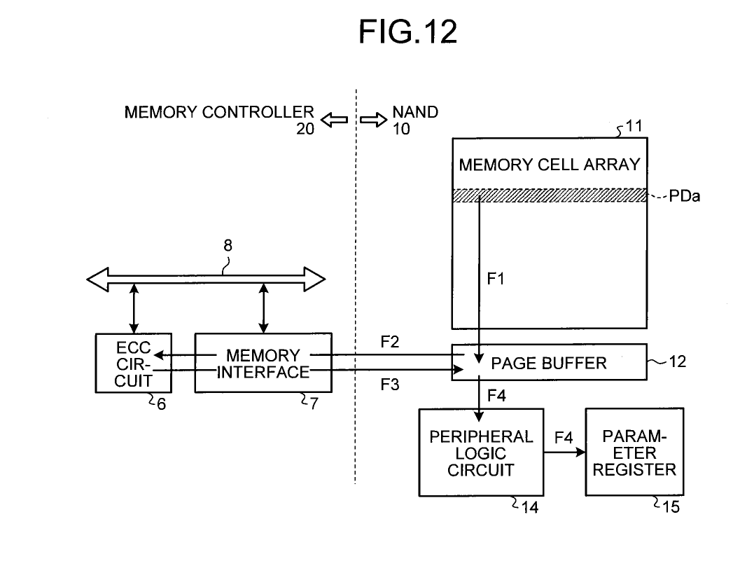

FIG. 12 is a conceptual diagram illustrating an error correcting operation of a memory system according to the third embodiment. In the third embodiment, it is assumed that one memory chip has only one parameter set group PDa as parameter data.

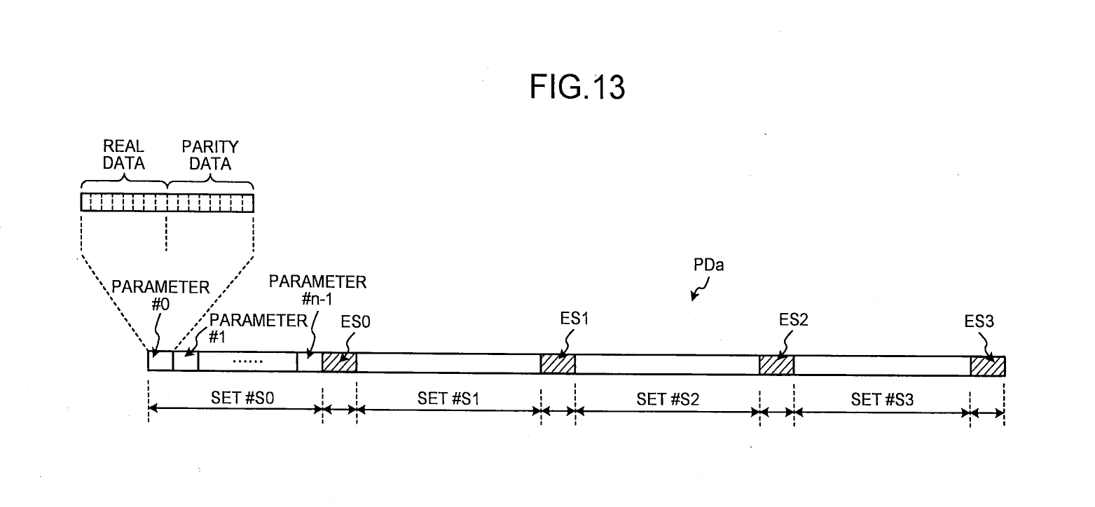

FIG. 13 illustrates a detailed configuration example of the parameter set group PDa. The parameter set group PDa has a plurality of parameter sets to provide multiplexing. In a case shown in FIG. 13, the parameter set group PDa has four parameter sets (sets #S0, #S1, #S2, and #S3). One parameter set includes plural different pieces of parameter data #0 to #n−1. One piece of parameter data includes real data and redundant data. In FIG. 13, parity data (a hamming code, for example) is used as the redundant data. Alternatively, complementary data can be used as the redundant data.

In the parameter set group PDa shown in FIG. 13, hatched error correcting codes (hereinafter, “parity portions”) ES0, ES1, ES2, and ES3 are added to the parameter sets, respectively. The parity portion ES0 is generated using the entire first parameter set #S0 as a frame, the parity portion ES1 is generated using the entire second parameter set #S1 as a frame, the parity portion ES2 is generated using the entire third parameter set #S2 as a frame, and the parity portion ES3 is generated using the entire fourth parameter set #S3 as a frame. The ECC circuit 6 of the memory controller 20 can perform error correction of the first parameter set #S0 using the parity portion ES0, perform error correction of the second parameter set #S1 using the parity portion ES1, perform error correction of the third parameter set #S2 using the parity portion ES2, and perform error correction of the fourth parameter set #S3 using the parity portion ES3.

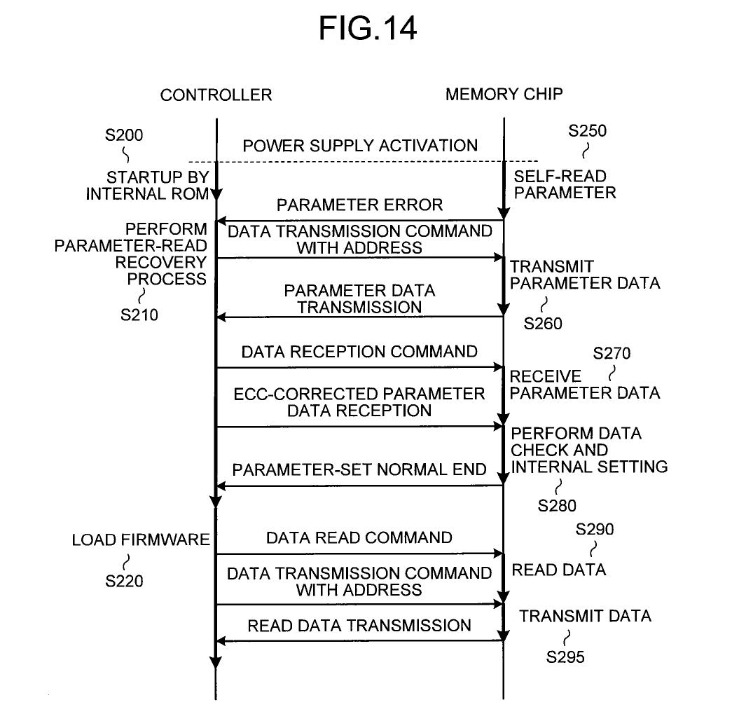

FIG. 14 illustrates operations of the memory controller 20 and each of the memory chips at the time of power supply startup of the memory system 100 according to the third embodiment. Also when a reset signal is transmitted from the memory controller 20 to each of the memory chips after the power supply startup, the memory controller 20 and the memory chips perform the operations shown in FIG. 14.

When the power supply is started, the startup program stored in the internal ROM 3 is executed so that the processor 5 of the memory controller 20 is started (S200). The startup program stored in the internal ROM 3 includes programs for performing processes at Steps S210 and S220.

Upon startup of the power supply, each of the memory chips performs a self-read operation of the parameter set group PDa including the parity portions ES0 to ES3 (Step S250) in the same procedure as shown in FIG. 6. A memory chip that has failed the self-read operation notifies the memory controller 20 of a parameter error. After notification of the parameter error, the memory chip transforms data in the page buffer 12 to an externally outputtable state. At a stage where the memory chip notifies the memory controller 20 of the parameter error, the parameter set group PDa including the parity portions ES0 to ES3 has been buffered in the page buffer 12 (an arrow F1 in FIG. 12).

When receiving the parameter error, the processor 5 of the memory controller 20 performs read of parameter data and a recovery process thereof using the ECC circuit 6 (Step S210). Specifically, the processor 5 of the memory controller 20 first transmits a data transmission command including an address of a block in which the parameter set group PDa is stored to the memory chip.

When receiving the data transmission command, the peripheral logic circuit 14 of the memory chip transmits the parameter set group PDa including the parity portions ES0 to ES3 buffered in the page buffer 12 to the memory controller 20 (Step S260, an arrow F2 in FIG. 12).

When receiving the parameter set group PDa, the ECC circuit 6 of the memory controller 20 performs error correction of the first parameter set #S0 using the parity portion ES0 of the parameter set group PDa, performs error correction of the second parameter set #S1 using the parity portion ES1, performs error correction of the third parameter set #S2 using the parity portion ES2, and performs error correction of the fourth parameter set #S3 using the parity portion ES3.

When the error correction process in the ECC circuit 6 is completed, the processor 5 of the memory controller 20 transmits a data reception command to the memory chip and further transmits the parameter set group PDa including the error-corrected first to fourth parameter sets #S0 to #S3 and the parity portions ES0 to ES3 to the memory chip.

When receiving the data reception command, the peripheral logic circuit 14 of the memory chip buffers the error-corrected parameter set group PDa in the page buffer 12 (Step S270, an arrow F3 in FIG. 12). The peripheral logic circuit 14 then performs the processes at Steps S106 to S126 shown in FIG. 6 using the parameter set group PDa buffered in the page buffer 12, thereby performing data check on the parameters and setting of the parameter data into the parameter register 15 (Step S280, an arrow F4 in FIG. 12). When the parameter read is completed normally, the peripheral logic circuit 14 of the memory chip notifies the memory controller 20 of a normal end of the parameter read.

When the parameter read operation using the error-corrected parameter set group PDa fails, the memory controller 20 is notified of a parameter error.

When receiving the normal end of the parameter read from each of the memory chips, the processor 5 of the memory controller 20 executes a read control on firmware from a desired memory chip (Step S220). Specifically, the processor 5 transmits a data read command including a page address at which the firmware is stored to the relevant memory chip and further transmits a data transmission command to the memory chip. Accordingly, when receiving the data read command and the data transmission command, the peripheral logic circuit 14 of the memory chip reads the firmware from the memory cell array 11 to buffer the firmware in the page buffer 12 (Step S290) and then transmits the firmware to the memory controller 20 (Step S295). The memory controller 20 stores the received firmware in the RAM 4 and the processor 5 executes the firmware stored in the RAM 4.

As described above, in the third embodiment, when parameter read fails, the ECC circuit 6 of the memory controller 20 performs error correction of parameter data and sets the error-corrected parameter data in the parameter register of a relevant memory chip. Therefore, the parameter data is protected by an error correction method with a higher correction capability of the memory controller 20, which improves the reliability of the parameter data.

### Fourth Embodiment

In a fourth embodiment, the refresh process of rewriting the parameter set group PDa before error correction with the parameter set group PDa error-corrected by the ECC circuit 6 in the memory controller 20 is added to the third embodiment.

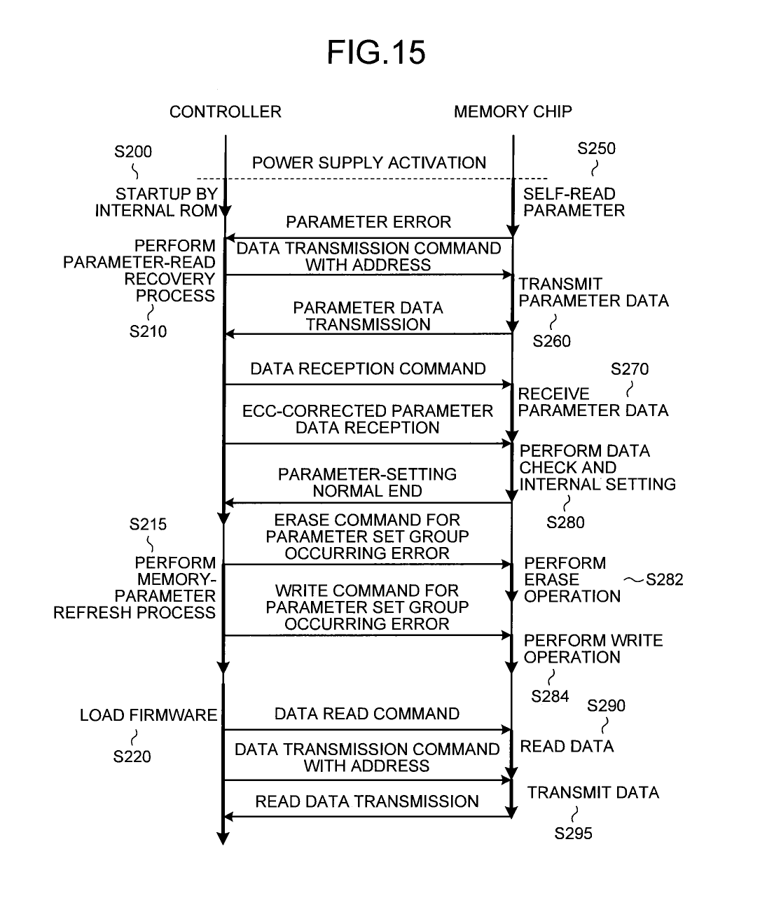

FIG. 15 illustrates operations of the memory controller 20 and each of the memory chips at the time of power supply startup of the memory system 100 according to the fourth embodiment. In FIG. 15, Steps S215, S282, and S284 are added to the flowchart shown in FIG. 14.

As shown in FIG. 15, the peripheral logic circuit 14 of a memory chip performs check of parameter data using the parameter set group PDa buffered in the page buffer 12 and error-corrected, and setting of the parameter data into the parameter register 15 at Step S280. When these processes are completed normally, the peripheral logic circuit 14 of the memory chip notifies the memory controller 20 of a normal end.

When receiving the normal end, the processor 5 of the memory controller 20 causes the memory chip to perform the refresh process of rewriting the uncorrected parameter set group PDa with the corrected parameter set group PDa (Step S215). Specifically, the processor 5 transmits an erase command including an address of a block in which the uncorrected parameter set group PDa is stored to the relevant memory chip.

When receiving the erase command, the peripheral logic circuit 14 of the memory chip erases the specified block (Step S282).

The processor 5 of the memory controller 20 transmits a write command including an address of a page in which the parameter set group PDa has been stored to the relevant memory chip.

When receiving the write command, the peripheral logic circuit 14 of the memory chip writes the data buffered in the page buffer 12 to the page specified by the write command. At that stage, the error-corrected parameter set group PDa has been buffered in the page buffer 12 and thus the error-corrected parameter set group PDa is written to the page in which the uncorrected parameter set group PDa has been stored. As a result, the refresh process of rewriting the uncorrected parameter set group PDa with the error-corrected parameter set group PDa is achieved.

In the fourth embodiment, the refresh process of rewriting a parameter set group for which a read error occurs with a parameter set group error-corrected in the memory controller 20 is performed. Therefore, the possibility of a read error in the parameter set group at the time of the next and succeeding startup is reduced and the parameter setting process is speeded up.

### Fifth Embodiment

In a fifth embodiment, a parameter reconfiguration process of rewriting pieces of parameter data (real data and a redundant portion) in which an error occurs during data check using the redundant portion with pieces of parameter data (real data and a redundant portion) for which the data check has ended normally is performed. It is more desirable that the parameter reconfiguration process is performed at a stage in which an error is likely to occur in parameter self-read.

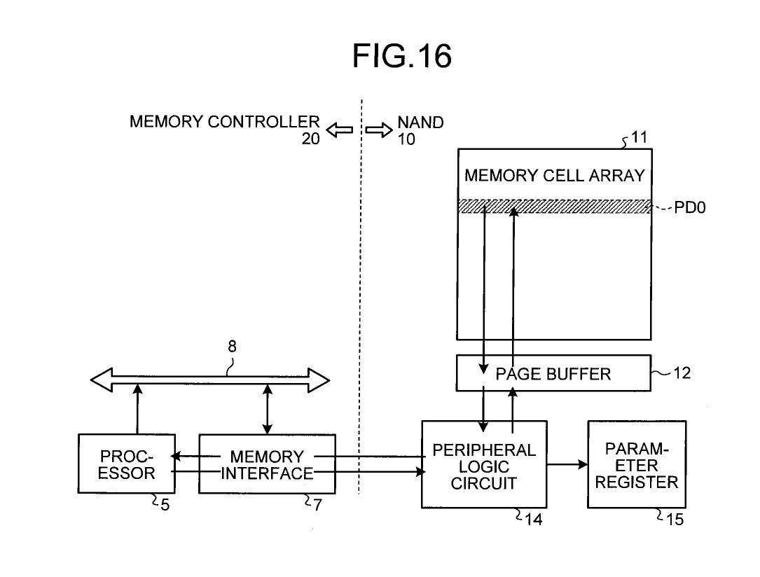

FIG. 16 is a conceptual diagram illustrating an error correcting operation of the memory system 100 according to the fifth embodiment. In the fifth embodiment, it is assumed that each of the memory chips has only one parameter set group PD0 as parameter data. The parameter set group PD0 has the data structure shown in FIG. 4 or 5.

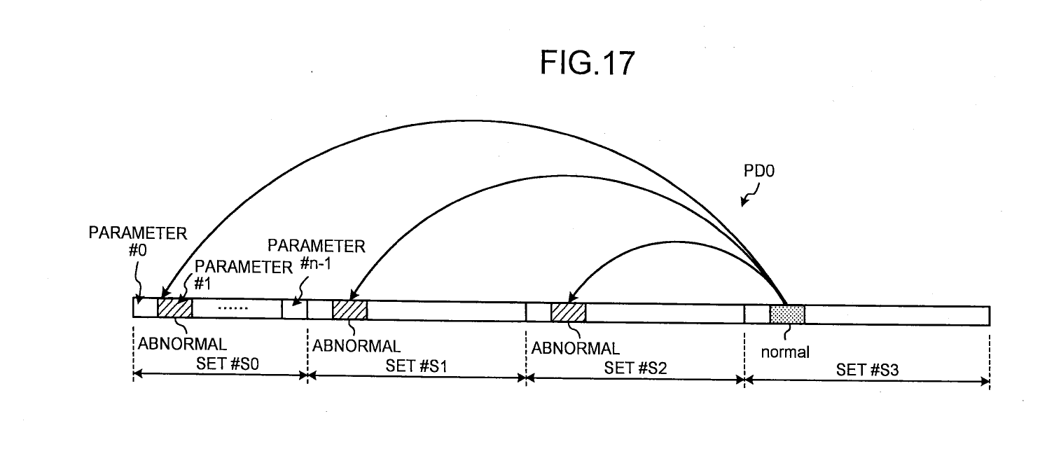

In FIG. 17, during data check, the parameter data #1 of the set #S0 is abnormal, the parameter data #1 of the set #S1 is abnormal, the parameter data #1 of the set #S2 is abnormal, and the parameter data #1 of the set #S3 is normal. The parameter reconfiguration process is performed in such a situation that the parameter data of the end set #S3 is set in the parameter register 15. In a case shown in FIG. 17, the parameter reconfiguration process of rewriting the parameter data #1 of the set #S0, the parameter data #1 of the set #S1, and the parameter data #1 of the set #S2, which are abnormal, with the normal parameter data #1 of the set #S3 is performed.

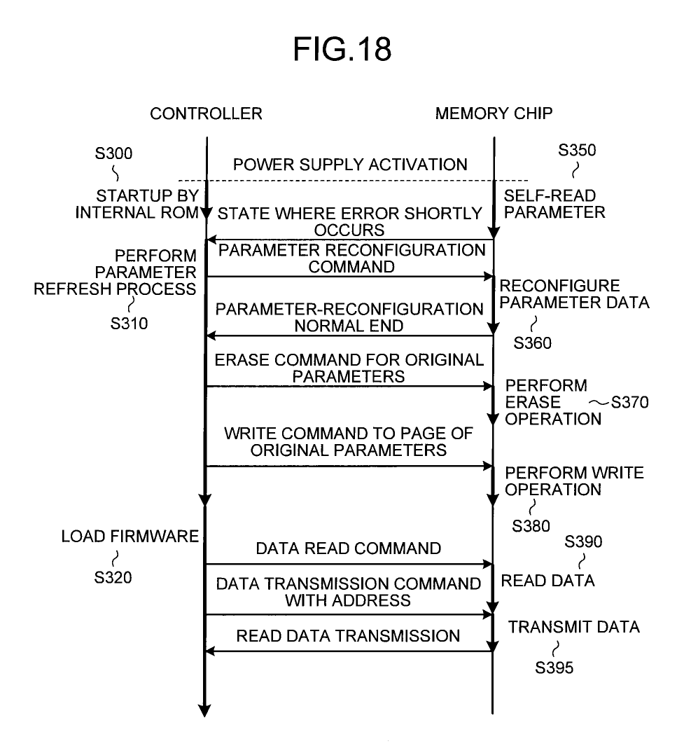

FIG. 18 illustrates operations of the memory controller 20 and each of the memory chips at the time of power supply startup of the memory system 100 according to the fifth embodiment.

When the power supply is started, the startup program stored in the internal ROM 3 is executed so that the processor 5 of the memory controller 20 is started (S300). The startup program stored in the internal ROM 3 includes programs for performing processes at Steps S310 and S320.

Upon startup of the power supply, each of the memory chips performs a self-read operation for the parameter set group PD0 in the same procedure as shown in FIG. 6 (Step S350). When a state in which a parameter error shortly occurs is detected in the self-read operation, a relevant memory chip notifies the memory controller 20 of a state where an error shortly occurs. Notification of a state where an error shortly occurs is issued when a defect occurs in not all of the parameter sets but more than a predetermined number of parameters. For example, when a defect occurs in two out of four sets or when a defect occurs in three out of four sets, the memory controller 20 is notified from the peripheral logic circuit 14 of the memory chip of a state where an error shortly occurs. When the notification is issued, the peripheral logic circuit 14 holds therein error map data indicating which piece of parameter data has been abnormal or normal in the parameter self-read operation.

When receiving the notification of the state where an error shortly occurs, the processor 5 of the memory controller 20 causes the memory controller to perform a process of refreshing the parameters (Step S310). Specifically, the processor 5 of the memory controller 20 first transmits a parameter reconfiguration command to the memory chip.

Upon reception of the parameter reconfiguration command, the peripheral logic circuit 14 of the memory chip performs reconfiguration of the parameter data on the page buffer 12 to rewrite parameter data of a set for which the read has ended abnormally with parameter data of a set for which the read has ended normally based on the error map data (Step S360). In FIG. 17, the parameter data #1 of the set #S0, the parameter data #1 of the set #S1, and the parameter data #1 of the set #S2, which are abnormal, are rewritten with the normal parameter data #1 of the set #3.

When the reconfiguration of the parameter data on the page buffer 12 in completed, the peripheral logic circuit 14 of the memory chip notifies the memory controller 20 of a normal end of the reconfiguration.

When receiving the normal end of the reconfiguration, the processor 5 of the memory controller 20 transmits an erase command including an address of a block in which the parameter set group PD0 is stored to the memory chip.

When receiving the erase command, the peripheral logic circuit 14 of the memory chip erases the specified block (Step S370).

The processor 5 of the memory controller 20 further transmits a write command including an address of a page in which the parameter set group PD0 has been stored to the memory chip.

Further, when receiving the write command, the peripheral logic circuit 14 of the memory chip writes data buffered in the page buffer 12 to the page specified by the write command. Because the parameter set group PD0 for which the reconfiguration of the parameter data has been performed has been buffered in the page buffer 12 at that stage, the reconfigured parameter set group PD0 is written to the page in which the original parameter set group PD0 has been stored. As a result, the refresh process of rewriting the original parameter set group PD0 with the reconfigured parameter set group PD0 is achieved (Step S380).

The processor 5 of the memory controller 20 then executes a read control on firmware from a desired memory chip (Step S320). Specifically, the processor 5 transmits a data read command including a page address at which the firmware is stored to the relevant memory chip and further transmits a data transmission command to the memory chip. Accordingly, When receiving the data read command and the data transmission command, the peripheral logic circuit 14 of the memory chip reads the firmware from the memory cell array 11 to buffer the firmware in the page buffer 12 (Step S390) and then transmits the firmware to the memory controller 20 (Step S395). The memory controller 20 stores the received firmware in the RAM 4 and the processor 5 executes the firmware stored in the RAM 4.

As described above, in the fifth embodiment, the parameter reconfiguration process of rewriting individual pieces of parameter data (the real data and the redundant portion) in which an error has occurred during data check with individual pieces of parameter data (the real data and the redundant portion) for which the data check has ended normally, respectively, is performed before parameter read fails in all sets. Therefore, a parameter read error can be prevented before occurrence.

While the reconfiguration of data is performed for each piece of parameter data in the above descriptions, a parameter set including an abnormal piece of parameter data can be rewritten with a parameter set including pieces of parameter data which are all normal.

The reconfiguration process according to the fifth embodiment can be applied to the memory system according to the first or second embodiment. That is, in a memory system having the memory chips multiplexed by the parameter set groups PD0 to PD2, the reconfiguration process mentioned above can be performed when a state where a parameter error shortly occurs is detected during a read process of each of the parameter set groups. In such a memory system, when a parameter error occurs, the parameter recovery process explained in the first or second embodiment is performed.

The reconfiguration process according to the fifth embodiment can be applied to the memory system according to the third or fourth embodiment. That is, the reconfiguration process mentioned above can be performed when a state where a parameter error shortly occurs is detected during a read process of one parameter set group PDa. In such a memory system, when a parameter error occurs, the parameter recovery process explained in the third or fourth embodiment is performed.

### Sixth Embodiment

In the second embodiment, when read of the first parameter set group PD0 has failed and read of the second parameter set group PD1 has been successfully performed, the first parameter set group PD0 is rewritten with the second parameter set group PD1 (see FIG. 3). In a sixth embodiment, when a state where a parameter error shortly occurs is detected during read of the first parameter set group PD0, read of the second parameter set group PD1 is performed and, when the second parameter set group PD1 has been successfully read, the first parameter set group PD0 is rewritten with the second parameter set group PD1. When the read of the second parameter set group PD1 has failed, read of the third parameter set group PD2 is performed and the first parameter set group PD0 and the second parameter set group PD1 are rewritten with the third parameter set group PD2.

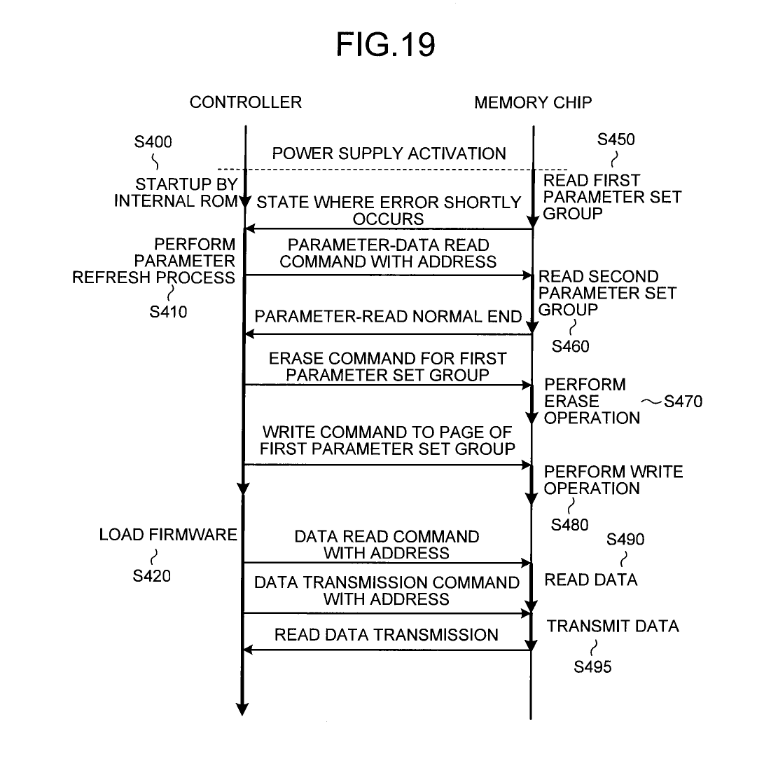

FIG. 19 illustrates operations of the memory controller 20 and each of the memory chips at the time of power supply startup of the memory system 100 according to the sixth embodiment.

When the power supply is started, the startup program stored in the internal ROM 3 is executed so that the processor 5 of the memory controller 20 is started (Step S400). The startup program stored in the internal ROM 3 includes programs for performing processes at Steps S410 and S420.

Upon startup of the power supply, each of the memory chips performs a self-read operation for the first parameter set group PD0 as shown in FIG. 6 (Step S450). In the self-read operation, when a defect occur in not all of parameter sets but more than a predetermined number of parameter sets as shown in FIG. 17, the peripheral logic circuit 14 determines that a parameter error shortly occurs and notifies the memory controller 20 of the effect.

When receiving the notification that a parameter error shortly occurs, the processor 5 of the memory controller 20 causes the relevant memory chip to perform refresh to rewrite the first parameter set group PD0 with the second parameter set group PD1 (Step S410). The processor 5 of the memory controller 20 first transmits a parameter-data read command including a page address at which the second parameter set group PD1 is stored to the memory chip.

When receiving the parameter-data read command, the peripheral logic circuit 14 of the memory chip reads the second parameter set group PD1 from the specified address in the memory cell array 11 and buffers the second parameter set group PD1 in the page buffer 12 (Step S460). During buffering into the page buffer 12, the peripheral logic circuit 14 performs error detection or error correction using the redundant portion in each piece of the parameter data and performs data check of each piece of the parameter data. When the read of the second parameter set group PD1 ends normally, the peripheral logic circuit 14 notifies the memory controller 20 of a parameter-read normal end.

When receiving the parameter-read normal end, the processor 5 of the memory controller 20 causes the relevant memory chip to perform the refresh process of rewiring the first parameter set group PD01 with the second parameter set group PD1. Specifically, the processor 5 transmits an erase command including an address of a block in which the first parameter set group PD01 is stored to the memory chip.

When receiving the erase command, the peripheral logic circuit 14 of the memory chip erases the specified block (Step S470).

The processor 5 of the memory controller 20 then transmits a write command including an address of a page in which the first parameter set group PD01 has been stored to the memory chip.

When receiving the write command, the peripheral logic circuit 14 of the memory chip writes data buffered in the page buffer 12 to the page specified by the write command. Because the second parameter set group PD1 has been buffered in the page buffer 12 at that stage, the second parameter set group PD1 is written to the page in which the first parameter set group PD0 has been stored. As a result, the refresh process of rewriting the first parameter set group PD01 with the second parameter set group PD1 is achieved.

When a read error occurs in the second parameter set group PD1, the refresh process of rewriting the first parameter set group PD0 and the second parameter set group PD1 with the third parameter set group PD2 is performed.

The processor 5 of the memory controller 20 then executes a read control on firmware from a desired memory chip (Step S420). Specifically, the processor 5 transmits a data read command including a page address at which the firmware is stored to the relevant memory chip and further transmits a data transmission command to the memory chip. Accordingly, when receiving the data read command and the data transmission command, the peripheral logic circuit 14 of the memory chip reads the firmware from the memory cell array 11 to buffer the firmware in the page buffer 12 (Step S490) and then transmits the firmware to the memory controller 20 (Step S495). The memory controller 20 stores the received firmware in the RAM 4 and the processor 5 executes the firmware stored in the RAM 4.

In the sixth embodiment, the refresh to rewrite the first parameter set group PD0 with the second parameter set group PD1 for which the read has been ended normally is performed in a situation where a read error shortly occurs in the first parameter set group PD0. Therefore, the possibility of a read error in the first parameter set group PD0 at the time of the next and succeeding startup is reduced and the parameter setting process is speeded up.

In the sixth embodiment, the first parameter set group PD0, the second parameter set group PD1, and the third parameter set group PD2 can be stored in different memory chips, respectively.

### Seventh Embodiment

In the first to sixth embodiments, firmware is loaded from the NAND 10 to the RAM 4 after read of parameter data in the memory chips ends. Accordingly, the first to sixth embodiments assume that software for executing the various controls related to the read of parameter data mentioned above (such as read of the second parameter set group PD1 at the time of a parameter read error and an error correction control using the ECC circuit 6) is loaded in the RAM 4 immediately after startup of the memory controller 20 and that the processor 5 operates based on the loaded software. For this purpose, a method such as mounting the various controls related to the read of parameter data mentioned above on the startup program stored in the ROM 3 or mounting various control programs related to the read of parameter data mentioned above on an external storage device other than the NAND 10 is required.

However, in some storage devices, a case occurs where it is necessary that firmware be stored in the memory chips of the NAND 10 and that the firmware be caused to have the various controls related to the parameter data read mentioned above. In such a case, when an error occurs in parameter self-read of each of the memory chips, the various controls related to the parameter data read mentioned above cannot be executed.

Generally, parameters to be used in each of the memory chips include parameters for various applications, such as ones defining internal voltages or operation timings related to read, write, and erase and ones adjusting timings of interfaces. Because these parameters are not yet set in each of the memory chips at the time of the parameter self-read, an operation to read parameters from the memory cell array 11 is generally performed at initial set values. That is, the initial set values have sufficient margins for timings and voltages and the memory chips can adequately operate at the initial set values only as for the read.

In a seventh embodiment, even when an error occurs in the parameter self-read, firmware for executing the various controls related to the parameter data read mentioned above is read at parameter initial set values and then the firmware is executed by the processor 5, whereby the various controls related to the parameter data read explained in the first to sixth embodiment are executed.

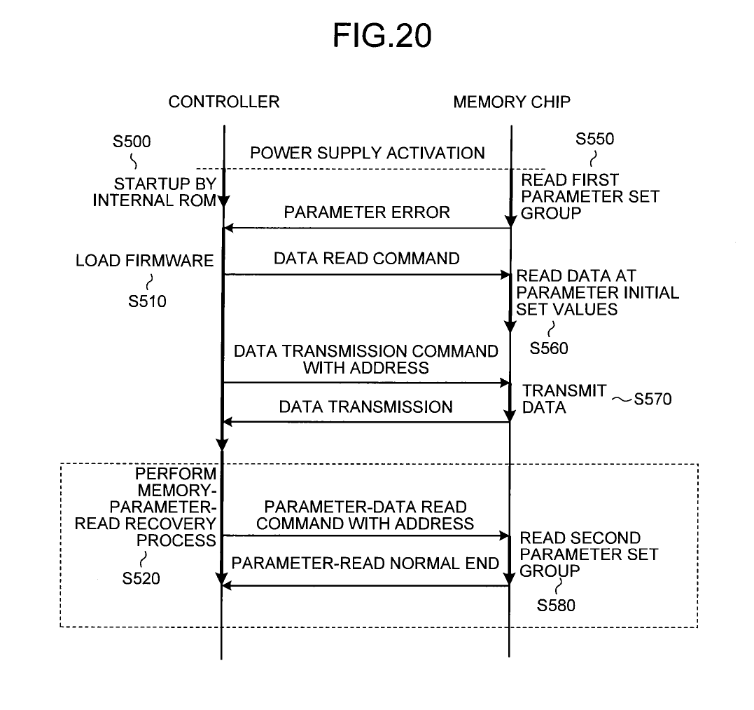

FIG. 20 illustrates operations of the memory controller 20 and each of the memory chips at the time of power supply startup of the memory system 100 according to the seventh embodiment. In a case shown in FIG. 20, the recovery process of memory parameter read according to the first embodiment is performed.

When the power supply is started, the startup program stored in the internal ROM 3 is executed so that the processor 5 of the memory controller 20 is started (S500). Upon startup of the power supply, each of the memory chips performs the self-read operation for the first parameter set group PD0 shown in FIG. 6 (Step S550). A memory chip that has failed the self-read operation notifies the memory controller 20 of a parameter error.

When receiving the parameter error, the processor 5 of the memory controller 20 executes a read control on firmware from the memory chip having notified of the parameter error (Step S510). Specifically, the processor 5 transmits a data read command including a page address at which the firmware is stored to the memory chip and further transmits a data transmission command to the memory chip. Accordingly, the peripheral logic circuit 14 of the memory chip reads the firmware from the memory cell array 11 at parameter initial set values to buffer the firmware in the page buffer 12 (Step S560) and then transmits the firmware to the memory controller 20 (Step S570). The memory controller 20 stores the received firmware in the RAM 4 and the processor 5 executes the firmware stored in the RAM 4.

The processor 5 of the memory controller 20 then performs a recovery process of the memory parameter read. For example, the processor 5 transmits a parameter-data read command including a page address at which the second parameter set group PD1 is stored to the relevant memory chip.

When receiving the parameter-data read command, the peripheral logic circuit 14 of the memory chip reads the second parameter set group PD1 from the specified address in the memory cell array 11 and buffers the second parameter set group PD1 in the page buffer 12. The peripheral logic circuit 14 performs the parameter read operation shown at Steps S106 to S126 in FIG. 6 using the second parameter set group PD1 buffered in the page buffer 12 and sets the pieces of parameter data in the parameter register 15. When the parameter data read ends normally, the peripheral logic circuit 14 of the memory chip notifies the memory controller 20 of a parameter-read normal end (Step S580).

The processes explained in the second to sixth embodiments can be performed under a control of the firmware read using the parameter initial set values.

As described above, in the seventh embodiment, even when an error occurs in the parameter self-read by a memory chip that has firmware stored therein in a situation where the recovery process of memory parameter read needs to be performed by the firmware stored in the NAND 10, the recovery process of the memory parameter read can be performed by the firmware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory controller that controls a nonvolatile memory, the nonvolatile memory having one memory chip or a plurality of memory chips, the memory controller comprising a controller configured to:
when notified by one of the memory chips of an error at a time of power supply startup, transmit a first command including an address to the memory chip by which the error was notified; and
when notified of a normal end by the memory chip in which the first command was received, transmit a second command including an address to the memory chip by which the normal end was notified.

2. The memory controller according to claim 1, wherein
each of the memory chips has data sets, each of the data sets including a plurality of pieces of parameter data for operating the memory chip, the data sets being multiple stored in the memory chip as first data and second data, and
the controller is configured to, when notified by one of the memory chips of a read error for the first data at a time of power supply startup, transmit a read command including an address of the second data as the first command to the memory chip by which the read error was notified.

3. The memory controller according to claim 2, wherein the controller is configured to, when notified by the memory chip of a read error for the first data at a time of power supply startup, instruct the memory chip by which the read error was notified to rewrite the first data with the second data.

4. The memory controller according to claim 2, wherein
the first data and the second data each includes a plurality of data sets, and
the controller is configured to, when notified by the memory chip that a read error for the first data shortly occurs at a time of power supply startup, instruct the memory chip by which the occurrence of the read error has been notified, to rewrite parameter data of a data set in which an error occurs with parameter data of a normal data set.

5. The memory controller according to claim 2, wherein
the first data and the second data each includes a plurality of data sets, and
the controller is configured to, when notified by the memory chip that a read error for the first data shortly occurs at a time of power supply startup, instruct the memory chip by which the occurrence of the read error has been notified, to rewrite the first data with the second data.

6. The memory controller according to claim 2, wherein the controller is configured to, when notified by the memory chip of a read error for the first data at a time of power supply startup, transmit a read command including an address of the second data to the memory chip by which the read error was notified after loading firmware from the memory chip.

7. A memory controller that controls a nonvolatile memory, the nonvolatile memory having one memory chip or a plurality of memory chips, the memory controller comprising a controller configured to:
when notified by one of the memory chips of an error at a time of power supply startup, transmit a first command for causing data to be transmitted from a memory chip, to the memory chip by which the error was notified;
after correcting data received from the memory chip, transmit corrected data to the memory chip; and
when notified by the memory chip in which the corrected data was received of a normal end, transmit a second command including an address to the memory chip by which the normal end was notified.

8. The memory controller according to claim 7, wherein
each of the memory chips has a data set, the data set including a plurality of pieces of parameter data for operating the memory chip and an error correcting code of the data set stored therein, and
the controller is configured to:
when notified by one of the memory chips of a read error for the data set at a time of power supply startup, transmit a first command for causing the data set and the error correcting code to be transmitted from the memory chip, to the memory chip by which the read error was notified; and
after correcting the data set received from the memory chip using the error correcting code, transmit a corrected data set and the error correcting code to the memory chip.

9. The memory controller according to claim 8, wherein the controller is configured to, when notified by the memory chip of a read error of the data set at a time of power supply startup, instruct the memory chip by which the read error was notified to rewrite the data set uncorrected and the error correcting code with the corrected data set and the error correcting code.

10. The memory controller according to claim 8, wherein
each of the memory chips has a plurality of data sets and error correcting codes of the data sets stored therein, and
the controller is configured to, when notified by one of the memory chips that a read error for one of the data sets shortly occurs at a time of power supply startup, instruct the memory chip by which the occurrence of the read error has been notified, to rewrite parameter data of the data set in which an error occurs with parameter data of a normal data set.

11. The memory controller according to claim 8, wherein the controller is configured to, when notified by the memory chip of a read error of the data set at a time of power supply startup, transmit the first command to the memory chip by which the read error was notified after loading firmware from the memory chip.

12. A memory system comprising a nonvolatile memory and a memory controller, the nonvolatile memory having one memory chip or a plurality of memory chips, the memory controller controlling the nonvolatile memory, wherein
each of the memory chips includes
a memory cell array having data sets, each of the data sets including a plurality of pieces of parameter data for operating the memory chip, the data sets being multiple stored as first data and second data, the pieces of parameter data each including a real data portion and a redundant portion,
a register in which parameter data is set, and
a peripheral circuit that performs a parameter read process of reading the first data from the memory cell array, performing data check to determine whether the read first data is normal using the redundant portion, and setting the first data in the register when the first data is normal, and notifying the memory controller of an error when the first data is abnormal,
the memory controller includes a controller configured to, when notified by one of the memory chips of an error at a time of power supply startup, transmit a first command including an address of the second data for instructing data read to the memory chip by which the error was notified, and wherein
the peripheral circuit performs the parameter read process for the second data when receiving the first command.

13. The memory system according to claim 12, wherein the controller is configured to, when notified by the memory chip of the error, instruct the memory chip by which the error was notified to rewrite the first data with the second data.

14. The memory system according to claim 12, wherein
the first data and the second data each includes a plurality of data sets, and
the controller is configured to, when notified by the memory chip that a read error for the first data shortly occurs at a time of power supply startup, instruct the memory chip by which the occurrence of the read error has been notified, to rewrite parameter data of a data set in which an error occurs with parameter data of a normal data set.

15. The memory system according to claim 12, wherein
the first data and the second data each includes a plurality of data sets, and
the controller is configured to, when notified by the memory chip that a read error for the first data shortly occurs at a time of power supply startup, instruct the memory chip by which the occurrence of the read error has been notified, to rewrite the first data with the second data.

16. The memory system according to claim 12, wherein the controller is configured to, when notified by the memory chip of a read error for the first data at a time of power supply startup, transmit a read command including an address of the second data to the memory chip by which the read error was notified after loading firmware from the memory chip.

17. A memory system comprising a nonvolatile memory that has one memory chip or a plurality of memory chips, and a memory controller that controls the nonvolatile memory, wherein
each of the memory chips includes
a memory cell array that has a data set including a plurality of pieces of parameter data for operating the memory chip and an error correcting code of the data set stored therein, the pieces of parameter data each including a real data portion and a redundant portion,
a register in which the pieces of parameter data are set, and
a peripheral circuit that reads the data set from the memory cell array, performing data check to determine whether the read data set is normal, and setting the pieces of parameter data in the register when the read data is normal, and notifying the memory controller of an error when the read data is abnormal,
the memory controller includes a controller configured to
when notified by one of the memory chips of the error at a time of power supply startup, transmit a first command for causing the data set and the error correcting code to be transmitted from the memory chip, to the memory chip by which the error was notified, and
after correcting the data set received from the memory chip using the error correcting code, transmit a corrected data set and the error correcting code to the memory chip, and wherein
the peripheral circuit performs data check to determine whether the corrected data set received from the memory controller is normal, and sets the pieces of parameter data in the register when the corrected data set is normal while notifying the controller of an error when the corrected data set is abnormal.

18. The memory system according to claim 17, wherein the controller is configured to, when notified by the memory chip of the error, instruct the memory chip by which the error was notified to rewrite the data set uncorrected and the error correcting code with the corrected data set and the error correcting code.

19. The memory system according to claim 17, wherein
each of the memory chips has a plurality of data sets and error correcting codes of the data sets stored therein, and
the controller is configured to, when notified by one of the memory chips that a read error for one of the data sets shortly occurs at a time of power supply startup, instruct the memory chip by which the occurrence of the read error has been notified, to rewrite parameter data of the data set in which an error occurs with parameter data of a normal data set.

20. The memory controller according to claim 17, wherein the controller is configured to, when notified by the memory chip of the error at a time of power supply startup, transmit the first command to the memory chip by which the read error was notified after loading firmware from the memory chip.
